(19) United States
(12) Patent Application Publication
(10) Pub. No.: US 2023/0307950 A1
(43) Pub. Date: Sep. 28, 2023

(54) POWER CABLE INTEGRATING AN AUTONOMOUS COMMUNICATING MEASUREMENT SYSTEM

(71) Applicants: NEXANS, Courbevoie (FR); SOCOMEC, BENFELD (FR)

(72) Inventors: Nicolas ROUSSELET, Saint-Genis-Laval (FR); Aymeric ANDRE, ANTIBES (FR); Clara LAGOMARSINI, Lyon (FR); Arnaud ALLAIS, Lyon (FR); Thierry SAVE, COULANGES LES NEVERS (FR); Dominique GAUTARD, VARENNES VAUZELLES (FR)

(21) Appl. No.: 18/020,912

(22) PCT Filed: Aug. 24, 2021
(86) PCT No.: PCT/FR2021/051479

§ 371 Date: Feb. 10, 2023

(30) Foreign Application Priority Data
Aug. 27, 2020 (FR) 20 08739

(51) Int. Cl. H02J 50/00; H02J 50/10; G01D 7/00; G01D 11/00

(52) U.S. Cl. CPC H02J 50/001; H02J 50/10; G01D 7/00; G01D 11/00; H01B 9/00

(57) ABSTRACT

This power cable comprises at least one conductive element and further comprises: at least one means (36) for measuring at least one physical quantity; at least one electronic circuit (32), connected to the measurement means (36) and suitable for receiving from the at least one measurement means (36) at least one signal representative of the at least one physical quantity; and at least one energy harvesting system (30) disposed inside the cable, suitable for supplying the at least one electronic circuit (32) with electrical energy from the electrical energy available in the at least one conductive element.

The present invention relates to a power cable incorporating a communicating autonomous measurement system.

More particularly, the purpose of the measurement system is to collect values of certain physical quantities relating to the state of the cable and/or to a system incorporating the cable and/or to the environment outside the cable, the autonomous feature referring to the self-powering of this system with electrical energy and the communicating aspect relating to the transmission of the collected values to the outside of the cable.

The invention relates to the field of power electrical cables intended to transport energy and/or transmit data. It is applicable in particular, but not solely, in fields as varied as that of infrastructure cables, railway cables or even wind turbines, more specifically at the instrumentation situated inside wind turbine towers.

The knowledge of various physical quantities relating to the state of a cable in operation without the need to directly access the cable is useful, in particular when this cable is installed in a place that is difficult to access, where any maintenance intervention is costly. Such is the case for example for cables installed in a wind turbine tower.

Measurements can be collected remotely, by bringing a sensor or another remote measurement system to an appropriate distance close to the cable concerned. Nevertheless, that requires the operator to transport the measurement system with him or her, including the means of supplying with current, to the site concerned and back, and do so as often as necessary. Furthermore, the operator must sometimes then perform an additional operation of transmission of the measurement results to a third party. Such a protocol is tedious and costly.

Also known, from the document WO 2014/026300, is an energy harvesting system founded on the principle of self-induction, which takes the energy from a power cable in which an electrical current is circulating and which supplies a strip of light-emitting diodes for the beaconage of a three-phase conductor. The energy harvester is composed of a ferromagnetic cable on which a copper winding is wound. The voltage is harvested at the ends of this winding.

Such an arrangement of the prior art cannot however be used to supply current to perform the abovementioned measurements and measurement result transmission operations, because it has a number of drawbacks. Firstly, the copper winding generally has a relatively significant bulk that is incompatible with installations in a reduced space. Furthermore, the flexibility of the assembly can be inadequate for a winding around conductors of small diameter. Moreover, this arrangement does not allow easy incorporation in an installation, and even less in an electrical cable. Such incorporation would in fact entail substantially modifying the cable.

The aim of the present invention is to remedy the abovementioned drawbacks of the prior art.

To this end, the present invention proposes a power cable comprising at least one conductive element, that is noteworthy in that it further comprises:
at least one means for measuring at least one physical quantity;
at least one electronic circuit, connected to the measurement means and suitable for receiving from the at least one measurement means at least one signal representative of said at least one physical quantity; and
at least one energy harvesting system disposed inside the cable, suitable for supplying the at least one electronic circuit with electrical energy from the electrical energy available in the at least one conductive element.

Thus, the cable according to the invention includes a miniaturized assembly comprising the measurement means, the electronic circuit and the energy harvesting system, the latter making it possible, without necessitating any power supply external to the cable, to supply sufficient energy to operate the measurement means via the electronic circuit. That makes it possible not only to dispense with having to separately transport this measurement and electrical power supply equipment, but also, through appropriate miniaturization, to keep the cable to a small diameter with the flexibility that allows easy installation on site.

In a particular embodiment, the electronic circuit is also disposed inside the cable.

The cable thus includes all of the elements necessary to the measurement, completely autonomously with respect to the supply of electrical energy. That makes it possible to pre-mount the assembly in the factory and also further facilitate the installation of the cable on site.

In a particular embodiment, the energy harvesting system comprises a plurality of coils mounted in series, each coil of this plurality of coils having a magnetic core and a predetermined number of turns.

By virtue of their magnetic core, these coils have a small bulk, which allows enough of them to be mounted in series for the energy harvesting system to collect the energy necessary to supply the measurement means via the electronic circuit.

In a particular embodiment in which the cable comprises at least two conductive elements, the energy harvesting system is disposed in at least one gap between these at least two conductive elements, at a minimal distance from these at least two conductive elements, such that the flux density of the magnetic field generated by the electrical current circulating in these at least two conductive elements is maximal.

That makes it possible to optimize the energy harvesting.

In a particular embodiment, the measurement means is disposed inside the cable. That even further simplifies the installation of the cable on site.

As a variant, the measurement means can be disposed on the cable. This variant makes it possible to provide a single pre-mounting in the factory, regardless of the measurement means subsequently envisaged, and to subsequently customize the cable by disposing the desired measurement means on top.

Advantageously, the cable comprises three conductive elements, that is to say that it is a three-phase cable. It is thus possible to place series-mountings of coils in the three gaps respectively located between each pair of phases of the cable.

As a variant, the cable can comprise four conductive elements, including a neutral, or even more conductive elements. That offers additional gaps to place the energy harvesting system or systems therein.

In a particular embodiment, the cable further comprises at least one radiofrequency device, suitable for transmitting to the outside of the cable data representative of the at least one signal representative of the at least one physical quantity.

There is thus a saving on multiple trips and interventions on the part of the operator to collect the measurement results, since the latter are transmitted to the outside of the cable by the radiofrequency device.

This radiofrequency device, also supplied with current by the energy harvesting system, can for example, but not necessarily, also be arranged inside the cable, with the energy harvesting system and possibly the measurement means and/or the electronic circuit. As a variant, the radiofrequency device can be disposed on the cable.

In both cases, that makes it possible to monitor the state of the cable without access to it and without providing an external electrical power source.

In a particular embodiment, the cable further comprises a storage means for the electrical energy harvested by the energy harvesting system.

This arrangement is advantageous because it makes it possible not to lose the electrical energy which would be collected by the energy harvesting system but which would not immediately be necessary for the operation of the various elements embedded in the cable.

In a particular embodiment, the at least one measurement means can comprise (the following list is not exhaustive): a current-carrying capacity sensor, suitable for measuring the maximum intensity admissible by the cable; and/or
a temperature sensor, suitable for measuring the temperature in a predetermined region of the cable; and/or
a pressure sensor, suitable for measuring the pressure in a predetermined region of the cable; and/or
an intensity sensor, suitable for measuring the intensity of the electrical current flowing through the cable; and/or
an electrical voltage sensor, suitable for measuring the electrical voltage at the terminals of a portion of the at least one conductive element; and/or
an electrical power sensor, suitable for measuring the electrical power available in the cable; and/or
a mechanical tension sensor, suitable for measuring the mechanical tension undergone by the cable; and/or
a location sensor, suitable for determining the geographic location of a predetermined region of the cable; and/or
a vibration sensor, suitable for measuring the vibrations in a predetermined region of the cable; and/or
a moisture sensor, suitable for determining the degree of moisture in a predetermined region of the cable; and/or
a gas flow rate sensor, suitable for determining the flow rate of a gas present in the environment of the cable; and/or
a gyroscopic sensor, suitable for determining the inclination of the cable.

The measurement means embedded in the cable thus has the advantage of making it possible to have a good knowledge of the state and the operation of the cable. It is thus possible to anticipate failures or malfunctions of the cable and consequently limit the repairs and production outages for the users of the cable.

In a particular embodiment, the cable further comprises at least one tube, or a hollow profile, inside which is housed the at least one electronic circuit and/or the at least one energy harvesting system and/or the at least one measurement means.

The tube thus constitutes a “false branch” that has the advantage of protecting the elements which are contained therein from damages caused for example by the mechanical or environmental stresses undergone by the cable.

The energy harvesting system and possibly the measurement means and/or the electronic circuit, if the latter are also disposed inside the cable, have a level of miniaturization that is sufficient to be able to be housed in the at least one tube such that this tube has an outer diameter of just a few millimeters, for example less than or equal to 25 mm.

Based on the application concerned, the tube can nevertheless have a greater diameter, depending on the space available for the tube in the cable concerned.

To the same end as that indicated above, the present invention also proposes an electrical energy harvesting system for harvesting electrical energy via a magnetic field induced by a circulation of current, noteworthy in that it comprises a plurality of coils mounted in series, each coil of the plurality of coils having a magnetic core and a predetermined number of turns.

To the same end as that indicated above, the present invention also proposes a wind turbine tower, noteworthy in that it comprises at least one cable as briefly described above.

The particular features and advantages of the energy harvesting system and of the wind turbine tower are similar to those of the cable, so they are not repeated here.

### BRIEF DESCRIPTION OF THE DRAWINGS

Other aspects and advantages of the invention will become apparent on reading the following detailed description of particular embodiments, given as nonlimiting examples, with reference to the attached drawings, in which:

FIG. 1 is a schematic representation of a cross section of a cable according to the present invention, in a particular embodiment;

FIG. 2 is an enlarged schematic representation of a coil with magnetic core included in a particular embodiment of a cable according to the present invention;

FIG. 3 is a functional schematic representation of elements relating to the cable according to the present invention, in a particular embodiment;

FIG. 4 is an enlarged schematic representation of a magnetic core of a coil included in a particular embodiment of a cable according to the present invention; and

FIG. 5 is a schematic representation of a three-phase cable according to the present invention, in a particular embodiment.

### DESCRIPTION OF EMBODIMENT(S)

The cable according to the present invention is an electrical power cable intended for example to transport energy and/or to transmit data. As a nonlimiting example, it can be a cable used to supply a wind turbine tower.

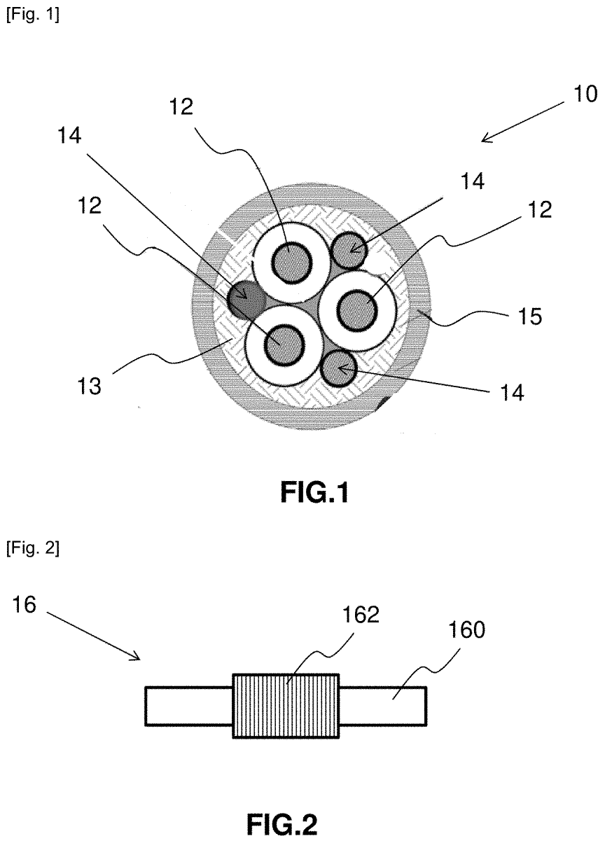

FIG. 1 shows a cross-sectional view of a cable 10 according to the present invention, in a particular embodiment.

The cable 10 comprises at least one conductive element 12. In the particular embodiment illustrated, the cable is three-phase and therefore comprises three conductive elements 12.

The cable represented on the drawing comprises conductive elements 12 with a cross-section of circular form. Nevertheless, this form is given as a nonlimiting example. Other forms are possible, such as a substantially flat cross-section for example.

Around each conductive element 12, it is possible to provide one or more layers of insulating material, which are themselves possibly, but not necessarily, covered with a mechanical barrier, for example of braid or tape type.

Optionally, the cable 10 can also comprise an inner sheath 13 and an outer sheath 15, this exemplary embodiment not however being limiting.

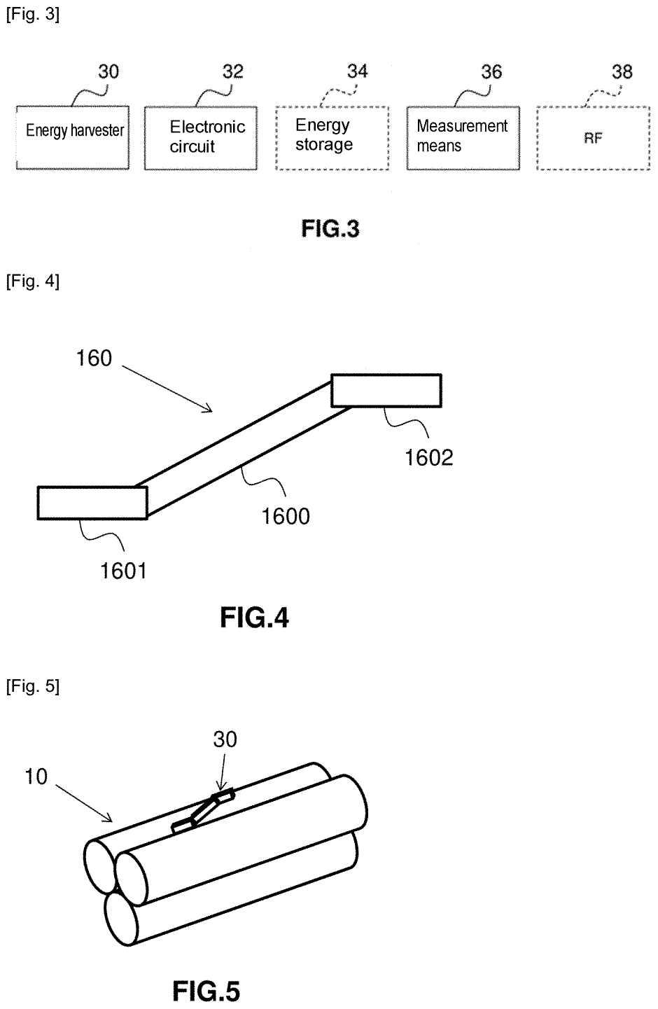

According to the invention, as the functional diagram of FIG. 3 illustrates, the cable 10 further comprises at least one means 36 for measuring at least one physical quantity relating to the state of the cable and/or to a system of which the cable forms part and/or to the environment outside the cable. This measurement means 36 can be disposed either inside the cable 10, or on or close to it, such that the measurement means 36 is adjacent to the cable 10 or in its near environment. Optionally, it is possible to envisage interrogating the measurement means 36 by radiofrequency communication, via a radiofrequency device 38 of the type described hereinbelow, present in the cable 10.

Possible measurement means 36 that can be cited in particular, as nonlimiting examples, the following list moreover not being exhaustive, include: a current-carrying capacity sensor suitable for measuring the maximum intensity admissible by the cable 10, a temperature sensor suitable for measuring the temperature in a predetermined region of the cable 10, a pressure sensor suitable for measuring the pressure in a predetermined region of the cable 10, an intensity sensor suitable for measuring the intensity of the electrical current flowing through the cable 10, an electrical voltage sensor suitable for measuring the electrical voltage at the terminals of a portion of the at least one conductive element, an electrical power sensor suitable for measuring the electrical power available in the cable 10, a mechanical tension sensor suitable for measuring the mechanical tension undergone by the cable 10, a location sensor suitable for determining the geographic location of a predetermined region of the cable 10, a vibration sensor suitable for measuring the vibrations in a predetermined region of the cable 10, a moisture sensor, suitable for determining the degree of moisture in a predetermined region of the cable 10, a gas flow rate sensor, suitable for determining the flow rate of a gas present in the environment of the cable 10, a gyroscopic sensor, suitable for determining the inclination of the cable 10, etc.

One or more measurement means 36, suitable for measuring a same physical quantity or physical quantities of different natures, can be embedded in the cable 10.

The one or more measurement means 36 can also be suitable for measuring one or more parameters relating to the environment outside the cable 10, such as, for example, the presence of gas using the abovementioned gas flow rate sensor, or the presence of people, these examples not being limiting.

According to the invention, the cable 10 also comprises at least one electronic circuit 32, connected to the at least one measurement means 36 and suitable for receiving, from the at least one measurement means 36, at least one signal representative of the at least one physical quantity.

Optionally, the electronic circuit 32 can also be disposed inside the cable 10.

The function of the electronic circuit 32 is to condition the signal transporting the electrical energy collected by an energy harvesting system 30 described later, namely to rectify and store this signal, for example via one or more capacitors or accumulators, in order to stabilize the signal to make it available to the one or more measurement means 36.

To this end, the electronic circuit 32 can, as a nonlimiting example, comprise a rectifier bridge and a DC-DC converter of step-up type, also called “boost” or “buck” converter or series chopper.

According to the invention, the cable 10 further comprises at least one energy harvesting system 30, possibly, but not necessarily, disposed inside the cable 10 and suitable for supplying electrical energy to the at least one electronic circuit 32 from the electrical energy available in the at least one conductive element 12.

The electrical energy originating from the electrical current circulating in the conductive element or elements 12 is in fact collected by one or more energy harvesting systems 30, which use the magnetic flux induced by this circulation of current to harvest the energy therefrom and, optionally, store it in an electrical energy storage means 34 such as a miniature battery, this electrical energy storage means 34 being also able, but not necessarily, to be arranged inside the cable 10, for example in the form of one or more capacitors or accumulators, for example forming part of the electronic circuit 32 described above.

An energy harvesting system 30 of the type contained in the cable according to the invention can for example, but not necessarily, be of the type described hereinbelow.

The energy harvesting system 30 can comprise a single coil 16 of the type represented in FIG. 2, or a plurality of coils 16, which can be mounted in series, in parallel or both, so as to obtain sufficient voltage and power levels. The number of coils 16 depends on the application targeted and on the space available in the cable 10. The power harvested is proportional to the number of coils 16.

Each coil 16 has a magnetic core 160 and a predetermined number of turns 162.

The magnetic core 160 is produced, for example, in a soft ferromagnetic material, such as an alloy of iron and nickel, for example with at least 36% nickel, or else an alloy of iron and silicon, or else a ferrite, or a nanocrystalline alloy or an amorphous material.

The turns 162 constitute a coil of insulated wire. When the coil is placed in a magnetic field, the latter induces the circulation of a magnetic flux in the core, which in turn induces a voltage at the terminals of the coil that is proportional to the amplitude of this flux, to the section of the core and to the number of turns of the coil. In the cable 10, the coil 16 or the coils 16 mounted in series are advantageously placed close to the conductive element or elements 12 according to an arrangement that makes it possible to have a maximum flux density induced in the core 160 by the abovementioned magnetic field.

The best possible trade-off between the length and the magnetic section of the cores is chosen. For example, in order to increase the length/magnetic section dimensional ratio, by increasing the length of the bar that can constitute the core 160 without increasing its height and without reducing the magnetic section, provision can be made for the core 160 of the coil 16 to comprise an assembly of at least two plates, for example cut from a single block, for example three plates, including a central plate 1600 inclined with respect to the direction of the magnetic field and two end plates 1601 and 1602 on either side of the central plate and parallel to one another, as illustrated in FIG. 4.

Many variant embodiments of the core 160 can be envisaged: the core 160 can comprise only the central plate 1600, inclined or not with respect to the direction of the magnetic field, the core 160 can be made of a single piece or in several parts, possibly but not necessarily assembled together, etc.

In a particular embodiment in which the cable 10 is a three-phase cable, the coils 16 and their cores 160 can then be positioned, for example, as illustrated in FIG. 5.

For example, in a particular embodiment in which the cable 10 comprises at least two conductive elements 12, the energy harvesting system or systems 30 are disposed in at least one gap between these conductive elements 12, at a minimal distance therefrom, such that the flux density of the magnetic field generated by the electrical current circulating in the conductive elements 12 is maximal.

The cable 10 can comprise a variable number of conductive elements 12.

In a particular embodiment, the cable 10 comprises four conductive elements 12, including a neutral.

In the particular embodiment of FIG. 1, in which the cable 10 is a three-phase cable, that is to say comprises three conductive elements 12, a predetermined number of coils 16 mounted in series are disposed in the gap between each pair of adjacent conductive elements 12.

More generally, any embodiment of the energy harvesting system 30, possibly other than the coils 16, is disposed such that the preferred axis of operation of the energy harvesting system 30 is parallel to the field lines of the induced magnetic field. In a three-phase cable, for example, in which the currents in each conductive element 12 are phase-shifted by 120°, the radial component of the resultant field is maximal between two phases. The energy harvesting system 30 is therefore disposed between two phases and positioned such that its preferred axis of operation is parallel to the field lines.

Furthermore, in the particular embodiment of FIG. 1, the cable comprises three tubes 14 in which the coils 16 are housed.

More generally, the cable 10 can comprise at least one tube 14 inside which are housed, either one, or some, or all of the following elements: electronic circuit(s) 32, energy harvesting system(s) 30, one or more measurement means 36.

The tube or tubes 14 can be cylindrical or possibly of flattened form. Their cross-section is not necessarily circular or elliptical. It can be triangular, rectangular or take any other form deemed appropriate in the application concerned.

As a nonlimiting example, if the tube or tubes 14 are cylindrical, they can have an outer diameter less than or equal to approximately 20 to 25 mm, preferably less than or equal to approximately 15 mm, preferably less than or equal to approximately 8 mm. The value of this diameter best suited to the dimension of the cross-section of the cable 10 considered will be chosen.

Moreover, the tube or tubes 14 can have a length of several tens of cm and can contain, at predetermined distance intervals, several sets each composed of at least the following elements: an energy harvesting system 30, an electronic circuit 32 and a measurement means 36 and, optionally, an electrical energy storage device 34 and a radiofrequency device 38.

Nevertheless, the presence of one or more tubes 14 is optional: the cable 10 according to the present invention may not include any tube 14.

As a nonlimiting example, for a three-phase cable 10, with coils 16 each having a number of turns of the order of 500, a length of approximately 70 to 80 mm and a height of approximately 5 to 10 mm, a copper section of between approximately 0.005 mm² and approximately 0.3 mm² and a magnetic core having a section of between 1 mm² and 3 mm², when the average intensity of the current flowing through the cable 10 is approximately 100 A, an average voltage of between 60 mV and 70 mV with a maximum voltage exceeding 100 mV can be obtained.

In a particular embodiment, the cable 10 further comprises, optionally, one or more radiofrequency devices 38 (for example of RFID, “radiofrequency identification” type, or of WiFi type), suitable for transmitting out of the cable 10 data representative of the at least one signal representative of the at least one physical quantity.

The radiofrequency device or devices 38 can be incorporated in the electronic circuit 32. The one or more measurement means 36 can also be incorporated in the electronic circuit 32.

The energy harvesting system 30 contained in the cable 10 supplies electrical current by electromagnetism to the electronic circuit 32 and therefore to the at least one measurement means 36 which is connected to the electronic circuit 32. This supply is delivered for example at regular time intervals, this time interval for example being able to depend on the energy storage capacity of the electrical energy storage means 34.

The energy harvesting system 30 can further supply electrical current to any other element present in or on the cable 10. As a nonlimiting example, the energy harvesting system 30 can supply one or more light-emitting diodes arranged in or on the cable 10, which thus becomes a self-lit cable, also called lighting cable.

The present invention provides a large measuring modularity, a wide variety of physical quantities reflecting the state of the cable being able to be measured through the adaptation of the electronic circuit or circuits 32 and a possible modification of the number of energy harvesting systems 30 and/or, in a particular embodiment, a possible modification of the number of coils 16 that they contain as necessary, depending on the consumption requirements of the various measurement means 36 involved.

The present invention makes it possible to incorporate all of the functions described previously in an existing cable without increasing the dimensions thereof, by virtue of the miniaturization of the various components of this assembly. Nor does the invention require the cable manufacturing process to be modified.

1. A power cable comprising:
at least one conductive element, and further having:
at least one means for measuring at least one physical quantity;
at least one electronic circuit, connected to said measurement means and suitable for receiving from said at least one measurement means at least one signal representative of said at least one physical quantity; and
at least one energy harvesting system disposed inside said cable, suitable for supplying electrical energy to said at least one electronic circuit from the electrical energy available in said at least one conductive element.

2. The power cable as claimed in claim 1, wherein said electronic circuit is disposed inside the cable.

3. The power cable as claimed in claim 1, wherein said energy harvesting system comprises a plurality of coils mounted in series and/or in parallel, each coil of said plurality of coils having a magnetic core and a predetermined number of turns.

4. The power cable as claimed in claim 1, comprising at least two conductive elements, wherein said energy harvesting system is disposed in at least one gap between said at least two conductive elements, at a minimal distance from said at least two conductive elements, such that the flux density of the magnetic field generated by the electrical current circulating in said at least two conductive elements is maximal.

5. The power cable as claimed in claim 1, wherein said at least one measurement means is disposed inside said cable.

6. The power cable as claimed in claim 1, wherein said at least one measurement means is disposed on said cable.

7. The power cable as claimed in claim 1, wherein said cable comprises three or four conductive elements.

8. The power cable as claimed in claim 1, wherein said cable further comprises at least one radiofrequency device, suitable for transmitting to the outside of said cable data representative of said at least one signal representative of said at least one physical quantity.

9. The power cable as claimed in claim 1, wherein said cable further comprises an electrical energy storage means, suitable for storing the electrical energy harvested by said energy harvesting system.

10. The power cable as claimed in claim 1, wherein said at least one measurement means comprises a current-carrying capacity sensor suitable for measuring the maximum intensity admissible by said cable and/or a temperature sensor suitable for measuring the temperature in a predetermined region of said cable and/or a pressure sensor suitable for measuring the pressure in a predetermined region of said cable and/or an intensity sensor suitable for measuring the intensity of the electrical current flowing through said cable and/or an electrical voltage sensor suitable for measuring the electrical voltage at the terminals of a portion of said at least one conductive element and/or an electrical power sensor suitable for measuring the electrical power available in said cable and/or a mechanical tension sensor suitable for measuring the mechanical tension undergone by said cable and/or a location sensor suitable for determining the geographical location of a predetermined region of said cable and/or a vibration sensor suitable for measuring the vibrations in a predetermined region of said cable and/or a moisture sensor, suitable for determining the degree of moisture in a predetermined region of said cable and/or a gas flow rate sensor, suitable for determining the flow rate of a gas present in the environment of said cable and/or a gyroscopic sensor, suitable for determining the inclination of said cable.

11. The power cable as claimed in claim 1, wherein said cable further comprises at least one tube inside which is housed said at least one electronic circuit and/or said at least one energy harvesting system and/or said at least one measurement means.

12. The power cable as claimed in claim 10, wherein said at least one tube is cylindrical and has an outer diameter less than or equal to 25 mm.

13. A wind turbine tower, wherein said wind turbine tower comprises at least one cable as claimed in claim 1.

14. An electrical energy harvesting system for harvesting electrical energy via a magnetic field induced by a circulation of current, wherein said electrical energy harvesting system comprises a plurality of coils mounted in series, each coil of said plurality of coils having a magnetic core and a predetermined number of turns.
